(19) United States
(12) Patent Application Publication
(10) Pub. No.: US 2006/0075351 A1
(43) Pub. Date: Apr. 6, 2006

(54) Method and apparatus for instant messaging prioritization

(75) Inventor: Sara Carlstead Brumfield, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/955,095

(22) Filed: Sep. 30, 2004

(51) Int. Cl. G06F 17/00; G06F 15/16

(52) U.S. Cl. 715/753; 709/206

(57) ABSTRACT

A method, apparatus, and computer instructions for indicating wait time for instant messages. An elapsed time since a response has been sent to a recipient in a chat session being displayed in a user interface is identified. A visual indication of the elapsed time is generated through the user interface. The indication indicates the elapsed time since the response has been sent to the recipient in the chat session.

### BACKGROUND OF THE INVENTION

1. Technical Field

The present invention relate generally to an improved data processing system, and in particular to a method and apparatus for processing data. Still more particularly, the present invention relates to a method, apparatus, and computer instructions for managing instant messaging data.

2. Description of Related Art

Instant messaging is an online chat medium, allowing users to communicate with each other and collaborate in real-time over a network data processing system. Instant messaging is commonly used over the Internet. Instant messaging applications monitor and report the status of users that have established each other as online contacts. This information is typically presented to a user in a window. Instant messaging applications also are often used by users conducting business. By utilizing instant messaging, business users can view each other's availability and initiate a text conversation with colleagues or customers when a desired contact becomes available.

Typically, with instant messaging applications, communications between users are initiated by users selecting the name of the person with which they desire to communicate. Then, the users type messages in a dialog box in the window and press “send”. These messages appear instantly on the other selected recipient's computer.

Until now, instant messaging has been developed largely for home users, but used by home and business users alike. Instant messaging allows an organization to deploy and utilize this “need-to-have” technology in a business setting.

Users may have multiple instant messaging sessions occurring at the same time. An instant messaging session also is referred to as a chat session. A user may have, for example, twenty windows for twenty different chat sessions displayed on the screen. Managing all of these chat sessions can be difficult. The user is able to identify whom the user owes responses to through various indicators, such as a flashing window or icon on a tool tray. The user, however, is unable to determine how long a recipient in a chat session has been waiting for a response with respect to other recipients for other chat sessions with the user through currently available instant messaging systems. As a result, the user may respond to some parties sooner than others.

Therefore, it would be advantageous to have an improved method, apparatus, and computer instructions for managing instant messaging sessions.

### SUMMARY OF THE INVENTION

The present invention provides a method, apparatus, and computer instructions for indicating wait time for instant messages. An elapsed time since a response has been sent to a recipient in a chat session being displayed in a user interface is identified. A visual indication of the elapsed time is generated through the user interface. The indication indicates the elapsed time since the response has been sent to the recipient in the chat session.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a diagram of an instant messaging system in accordance with a preferred embodiment of the present invention;

FIG. 5 is a diagram illustrating components used in an instant messaging system in accordance with a preferred embodiment of the present invention;

FIG. 6 is a diagram illustrating graphical indications based on elapsed time in accordance with a preferred embodiment of the present invention;

FIG. 7 is a flowchart of a process for managing timers for chat sessions in accordance with a preferred embodiment of the present invention; and

FIG. 8 is a flowchart of a process for generating indications for a chat session in accordance with a preferred embodiment of the present invention.

### DETAILED DESCRIPTION OF THE PREFERRED EMBODIMENT

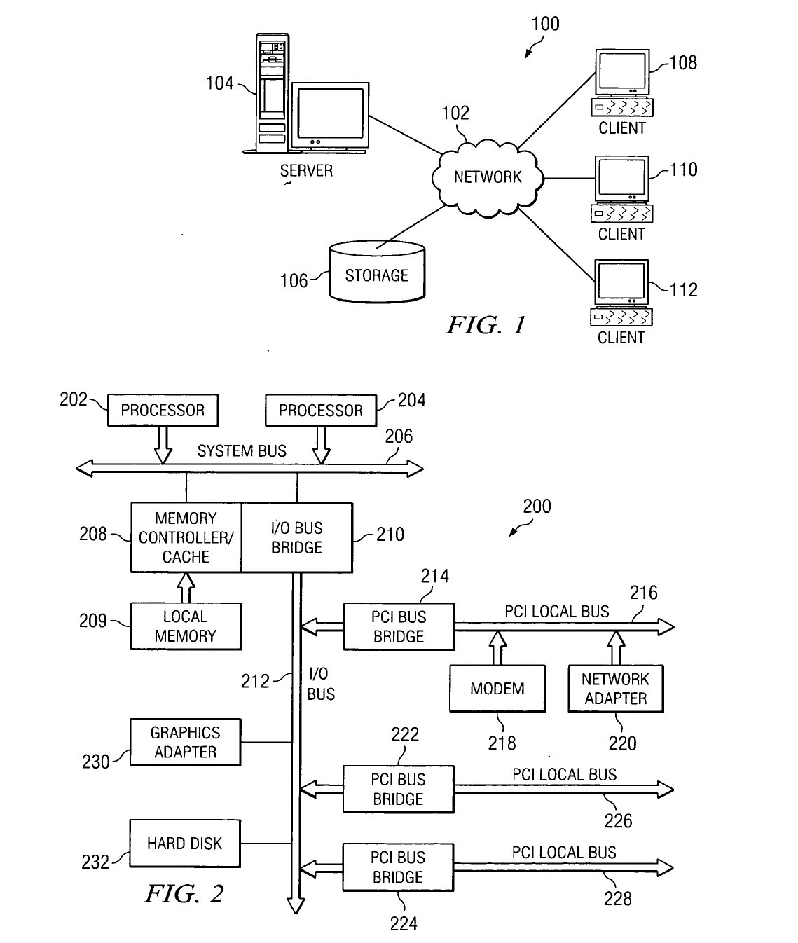

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

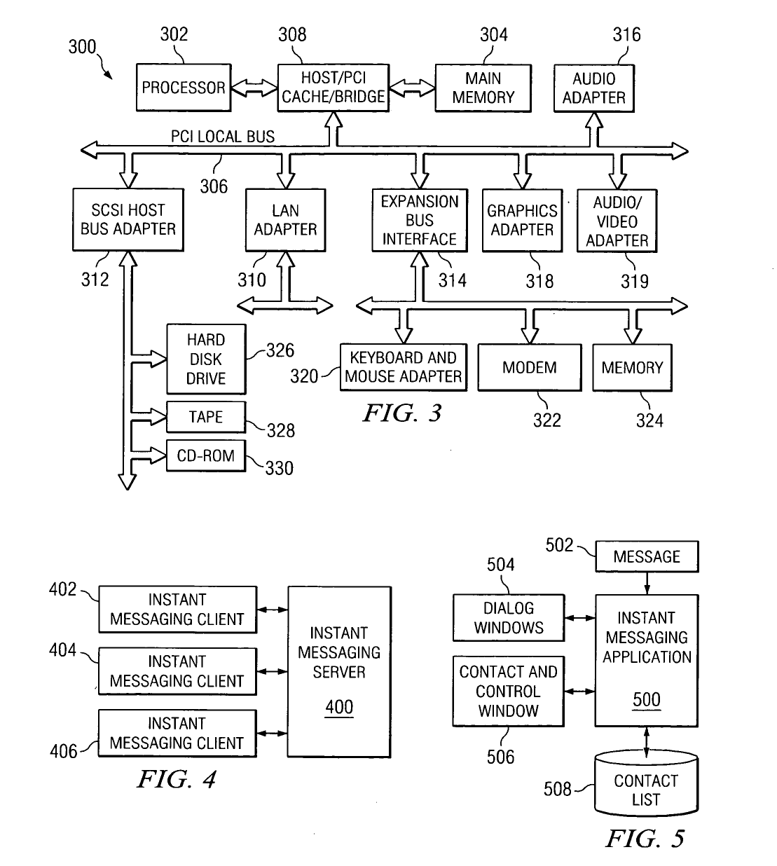

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI Bridge 308. PCI Bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only-memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides a method, apparatus, and computer instructions for managing chat sessions in an instant messaging system. The mechanism of the present invention identifies an elapsed time since a response or reply has been sent to a recipient in a chat session displayed in a user interface. An identification of the elapsed time is generated through a user interface. This indication provides an indication of the elapsed time that has passed since a response has been sent to the recipient or other party in a chat session.

The present invention recognizes that some currently available instant messaging systems provide information as to how long a recipient has been idle. This type of information indicates how much time has past since the recipient or sender has worked in the chat session. Further, this idle time information also typically requires the user to open the chat session window. This currently available system does not provide an easy or simple mechanism for the user to determine which recipients have been waiting the longest for the reply.

The mechanism of the present invention provides a visual indication as to how long different parties have been waiting for a response or reply from the user. Further, in providing this visual indication, the mechanism of the present invention does not require a user input to generate the visual indication for the different chat sessions. In the illustrative embodiments, a speed at which an icon on a tool tray flashes may be set based on how long a recipient has been waiting for a response or reply. In these examples, the icon flashes faster when a party has been waiting longer for a response in contrast to another party who has been waiting a shorter period of time.

Of course, other types of indications may be used. For example, different colors may be used in presenting the icon for the different chat sessions. A warming sequence of colors may be used with red indicating a “hot” chat session; this session is a chat session with the longest elapsed period of time since a previous response. These graphical indications may be applied to the windows in which the chat sessions are displayed. For example, the elapsed time may be displayed in association with the chat session. In another example, graphical shapes may be displayed with the icon to indicate the amount of elapsed time since a reply since the user to a recipient. Other examples of graphical indications include, for example, hue or color intensity, timer numbers in the tool tray icon, and flashing speed for icons.

Turning now to FIG. 4, a diagram of an instant messaging system is depicted in accordance with a preferred embodiment of the present invention. In this illustrative example, instant messaging server 400 provides a location for clients, such as instant messaging clients 402, 404, and 406, to login. After logging into instant messaging server, these clients may exchange messages directly with each other or through instant messaging server 400.

In these examples, the mechanism of the present invention may be implemented within an instant messaging client, such as instant messaging client 406. Chat sessions handled by instant messaging client 402 are presented using graphical indications to identify how long parties to a chat session have been waiting for a response to a message. In these illustrative examples, the elapsed time is tracked within instant messaging client 402. In the instance in which messaging are passed through instant messaging server 400, rather than directly between clients, the elapsed time may be tracked by instant messaging server 400.

Turning next to FIG. 5, a diagram illustrating components used in an instant messaging system is depicted in accordance with a preferred embodiment of the present invention. In the depicted example, instant messaging application 500 processes messages, such as message 502 received from users located on remote data processing systems. As messages are received, these messages are presented in dialog windows 504. Messages exchanged between instant messaging application 500 and an instant messaging application on a remote data processing system form a conversation in these examples.

Additionally, dialog windows 504 provide an interface for user input to send messages to other users. Contact and control window 506 is presented by instant messaging application 500 to provide the user with a list of user names, as well as other information, such as, for example, identifying other users that are currently online. Contact and control window 506 also provides an interface to allow the user to set different preferences. For example, the user may set passwords required to access different names used in instant messaging sessions. Further, a user may employ contact and control window 506 to set other preferences, such as colors and fonts used in instant messaging application 500.

Further, the list of names presented by contact and control window 506 is stored in contact list 508 in these examples. Additional user names may be added or deleted from contact list 508. This contact list is employed in presenting the list of names within contact and control window 506. Additionally, the user may view the status of other users on contact and control window 506. This status may be, for example, available or busy. When the status is available, instant messaging application 500 will accept messages from another instant messaging application to start a new conversation. When the status of another user is busy, messages from instant messaging application 500 are not accepted by the other application for that user.

In these examples, instant messaging application 500 creates a timer for each chat session. Whenever a message is received for a chat session, the timer for that chat session is started. The timer is stopped when the user responds or replies to the message. Additionally, the timer also may be stopped after the last response has been received, rather than when the user sends a response or message. This timer is check by instant messaging application 500 on a periodic basis in these examples. The elapsed time in the timer is used to identify an appropriate identification for the chat session. In this illustrative embodiment, the elapsed time is looked up in a table to identify settings, such as color and/or flashing speed. Based on this lookup, the color of the icon and/or flashing speed is adjusted depending on how much time has elapsed.

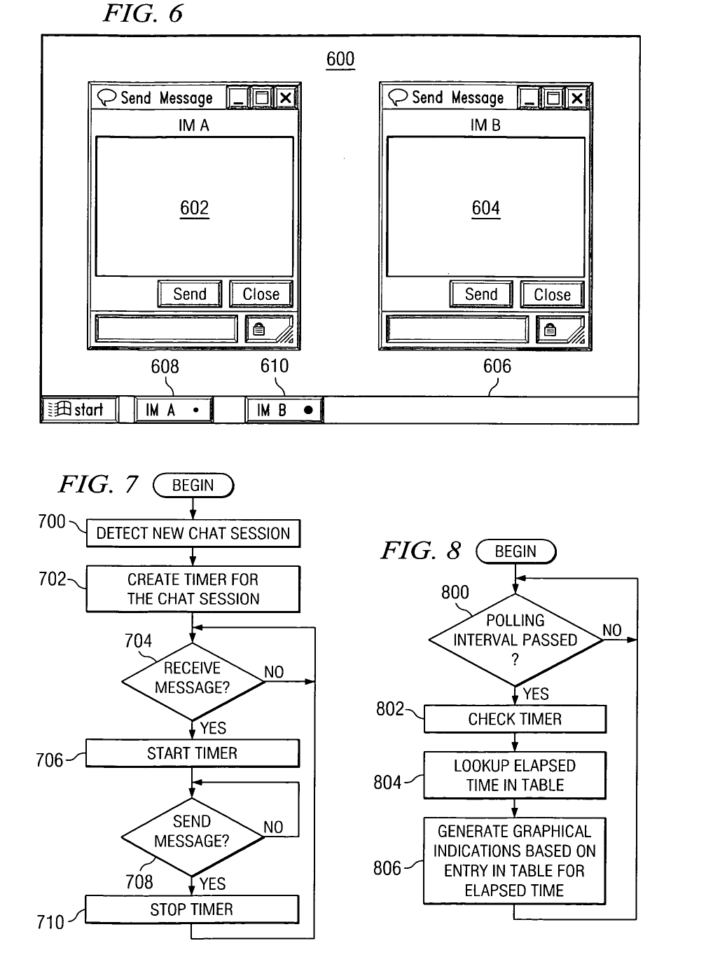

Turning now to FIG. 6, a diagram illustrating graphical indications based on elapsed time is depicted in accordance with a preferred embodiment of the present invention. In this example, two chat sessions are shown in display 600. These two chat sessions are displayed in windows 602 and 604. Icons for these two chat sessions are displayed on tool tray 606. Tool tray 606 is a graphical component in a graphical user interface that provides an identification of windows that are currently present in the graphical user interface even though the user may be unable to view all of the windows present. Tool tray 606 is located at the bottom of the display, but may be placed in other locations, such as, at the top or sides of the display. Icon 608 is associated with window 602, while icon 610 is associated with window 604.

The flashing speed and/or color of icon 608 and 610 are adjusted based on the elapsed time since a last response or reply has been made by a user. For example, the flashing speed of icon 608 is set to a faster speed relative to the flashing speed of icon 610 if more time has elapsed since a last reply has been made for the chat session in window 604. Further, the graphical indication may include a flashing speed for window 602 and 604. Other graphical indications, such as, for example, colors selected for icon 608 and 610 or window 602 and 604 may be used. These colors are used to indicate comparable elapsed times for the different chat sessions in these illustrative examples.

Of course, other types of graphical indications may be used. For example, the amount of elapsed time that has passed may be indicated within the icons in tool tray 606 using graphical shapes within the icons. As illustrated, icon 608 includes a circle and icon 610 contains a larger circle. The difference in the size of the circle is used to indicate the amount of time that has elapsed for a chat session relative to other chat sessions. As depicted, the chat session associated with icon 610 indicates that more time has elapsed since the last reply was sent as compared to the chat session for icon 608.

In FIG. 7, a flowchart of a process for managing timers for chat sessions is depicted in accordance with a preferred embodiment of the present invention. The process illustrated in FIG. 7 may be implemented in a component such as instant messaging application 500 in FIG. 5.

The process begins by detecting a new chat session (step 700). Next, a timer is created for the chat session (step 702). A determination is made as to whether a message has been received for the chat session (step 704). If a message has been received, the timer is started (step 706). Thereafter, a determination is made as to whether a message has been sent in reply or response to the received message (step 708). If a message has been sent, the timer is stopped (step 710) with the process then returning to step 704 as described above.

In step 704, if a message has not been received, the process returns to step 704. With reference again to step 708, if a message has not been sent, the process continues to return to step 708.

With reference now to FIG. 8, a flowchart of a process for generating indications for a chat session is depicted in accordance with a preferred embodiment of the present invention. The process illustrated in FIG. 8 may be implemented in a component, such as instant messaging application 500.

The process begins by determining whether a polling interval has passed (step 800). This polling interval may be set at different intervals depending on the particular implementation. If a polling interval has not passed, the process continues to return to step 800.

Otherwise, the timer for that chat session is checked to identify an elapsed time (step 802). The elapsed time is looked up in a table to identify the setting for one or more of the graphical indications for the chat session (step 804). The indications identified in an entry in the table for the elapsed time are generated in the display of the chat session (step 806) with the process then returning to step 800 as described above.

Thus, the present invention provides an improved method, apparatus, and computer instructions for facilitating instant messaging prioritization based on who has been waiting the longest for a reply or response. The mechanism of the present invention identifies the elapsed time since a reply has been made for a chat session. Based on the elapsed time, a graphical indication is generated for the chat session. This indication may take various forms, including, for example, a flashing speed and/or color for the chat window and/or an icon in a tool tray. In this manner, a user may identify how much time has elapsed since a last response was sent for a chat session relative to other chat sessions.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for indicating wait time for instant messages, the method comprising:
identifying an elapsed time since a response has been sent to a recipient in a chat session being displayed in a user interface; and
generating an indication of the elapsed time through the user interface, wherein the indication indicates the elapsed time since the response has been sent to the recipient in the chat session.

2. The method of claim 1, wherein the identifying step comprises:
starting a timer for the chat session when a message is received from a user;
checking the timer for the chat session;
selecting a particular type of indication based on the timer; and
presenting the particular type indication through the user interface.

3. The method of claim 2 further comprising:
stopping the timer in response to a reply to the message being sent to the user.

4. The method of claim 2, wherein the particular type of indication is selected from a table.

5. The method of claim 1, wherein the identifying step is performed periodically.

6. The method of claim 2, wherein the particular type of indication includes at least one of a color, a flashing speed, a sound, and a graphical indicator.

7. The method of claim 1, wherein the identifying step and the generating step is performed for each chat session being displayed in the user interface.

8. A data processing system for indicating wait time for instant messages, the data processing system comprising:
identifying means for identifying an elapsed time since a response has been sent to a recipient in a chat session being displayed in a user interface; and
generating means for generating an indication of the elapsed time through the user interface, wherein the indication indicates the elapsed time since the response has been sent to the recipient in the chat session.

9. The data processing system of claim 1, wherein the identifying means comprises:
starting means for starting a timer for the chat session when a message is received from a user;
checking means for checking the timer for the chat session;
selecting means for selecting a particular type of indication based on the timer; and
presenting means for presenting the particular type indication through the user interface.

10. The data processing system of claim 9 further comprising:
stopping means for stopping the timer in response to a reply to the message being sent to the user.

11. The data processing system of claim 9, wherein the particular type of indication is selected from a table.

12. The data processing system of claim 8, wherein the identifying means is initiated periodically.

13. The data processing system of claim 9, wherein the particular type of indication includes at least one of a color, a flashing speed, a sound, and a graphical indicator.

14. The data processing system of claim 8, wherein the identifying means and the generating means is identified for each chat session being displayed in the user interface.

15. A computer program product in a computer readable medium for indicating wait time for instant messages, the computer program product comprising:
first instructions for identifying an elapsed time since a response has been sent to a recipient in a chat session being displayed in a user interface; and
second instructions for generating an indication of the elapsed time through the user interface, wherein the indication indicates the elapsed time since the response has been sent to the recipient in the chat session.

16. The computer program product of claim 15, wherein the first instructions comprises:
first sub instructions for starting a timer for the chat session when a message is received from a user;
second sub instructions for checking the timer for the chat session;
third sub instructions for selecting a particular type of indication based on the timer; and
fourth sub instruction for presenting the particular type indication through the user interface.

17. The computer program product of claim 16 further comprising:
third instructions for stopping the timer in response to a reply to the message being sent to the user.

18. The computer program product of claim 16, wherein the particular type of indication is selected from a table.

19. The computer program product of claim 15, wherein the first instructions are executed periodically.

20. The computer program product of claim 16, wherein the particular type of indication includes at least one of a color, a flashing speed, a sound, and a graphical indicator.

21. The computer program product of claim 15, wherein the first instructions and the second instructions are executed for each chat session being displayed in the user interface.
